(19) United States
(12) Patent Application Publication
(10) Pub. No.: US 2017/0273254 A1
(43) Pub. Date: Sep. 28, 2017

(54) A MULTI-STACKING DECORATIVE FLOWERPOT UNIT

(71) Applicants: Takami ITO, Aichi (JP); Yoshihide ITO, Aichi (JP); Erika MIYAZAKI, Osaka (JP); Mitsuyo OOKAWA, Hiroshima (JP)

(72) Inventors: Takami ITO, Aichi (JP); Yoshihide ITO, Aichi (JP); Erika MIYAZAKI, Osaka (JP); Mitsuyo OOKAWA, Hiroshima (JP)

(21) Appl. No.: 15/502,286

(22) PCT Filed: May 12, 2016
(86) PCT No.: PCT/JP2016/064128

§ 371 Date: Feb. 7, 2017

(30) Foreign Application Priority Data
Oct. 28, 2015 (JP) 2015-211681
May 6, 2016 (JP) 2016-093047

(51) Int. Cl. A01G 9/02; A01G 27/00

(52) U.S. Cl. CPC A01G 9/023; A01G 27/005

(57) ABSTRACT

The multi-stacking decorative flowerpot unit (1) comprising: a pole (2) extending vertically, a plurality of flowerpots (3) having a through hole (3a), which is formed in a bottom part of the flowerpot (3) in order to pass the pole (2) though the flowerpot (3), and a spacer (4) having a cylindrical shape and being placed between adjacent upper and lower flowerpots (3). And the pole (2), the flowerpot (3), and the spacer (4) are united by passing the through hole (3a) and the spacer (4) through the pole (2). This configuration makes it possible for many plants to be placed in a small space such as a room. And work efficiency and workability are improved, and the flexibility of its design and the quality of its display are enhanced by this invention.

### BACKGROUND OF THE INVENTION

1. Field of the Invention

The present invention relates to a multi-stacking decorative flowerpot unit, which is able to stack a plurality of flowerpots by using a pole, which extends vertically.

2. Description of the Related Art

These days, a vertical wall-surface greening, which is located along wall-surface of buildings or wall-surface of architectures and is not only for outdoor greening but also for indoor greening, is becoming popular. This wall-surface greening has lots of effects, such as healing, relaxation surrounded by the green, and amenity improvement. What is more, it has other effects such as purifying air, moisturizing dry air in winter, and so on.

As a conventional technique for indoor greening, a container is widely used. This container is easy to carry so that it is placed in various places. And, a standardized systematic container with good construction efficiency is also widely used to make indoor environment green.

By the way, a system for placing a plurality of pots in a vertical direction and placing plants into the pots has already disclosed. For example, a vertical plant pot, which has a pole part inside, is disclosed (refer to official publication of Japanese Laid-Open Patent Application No. 2004-121199). Herein, the top of the pole part has a saucer, and the upper plant pot is placed onto the saucer. Further, a vertical planting apparatus, which comprises a water storing box and a plurality of plant pots for stacking, is disclosed (refer to official publication of Japanese Utility Model Registration No. 3168954).

### BRIEF SUMMARY OF THE INVENTION

However, in the method of the vertical wall-surface greening described above, there are still some problems. For example, if the flexibility of its design is enhanced, whereas work efficiency is degraded. If work efficiency is enhanced, whereas the flexibility of its design is degraded and sometimes it requires maintenance work in terms with irrigation system, Therefore, it is necessary to realize a vertical green apparatus having good work efficiency, design flexibility, and easy maintenance concerning irrigation system.

Moreover, it is expected that there appears a new type of the vertical green apparatus, which can place many plant pots in various places without using large indoor space and can create a beautiful design with many plants shortly.

The present invention is conceived in view of issues such as those mentioned above and has as a first objective to provide a multi-stacking decorative flowerpot unit that can be placed many plants without requiring large indoor space, and that makes it possible for work efficiency to be better and for its designability to be enhanced.

### DISCLOSURE OF INVENTION

In order to solve the aforementioned issues, the present invention is a multi-stacking decorative flowerpot unit comprising: a pole extending vertically; a plurality of flowerpots having a through hole, which is formed in a bottom part of the flowerpot in order to pass the pole through the flowerpot; and a spacer having a cylindrical shape and being placed between adjacent upper and lower flowerpots in order to stack the flowerpot at a specific interval in a vertical direction, wherein the pole, the flowerpot, and the spacer are united by passing the through hole and the spacer through the pole.

In this multi-stacking decorative flowerpot unit, preferably, wherein the flowerpot has a cylindrical protrusion on bottom thereof, and the through hole is formed on the top of the cylindrical protrusion, and the cylindrical protrusion has a hollow portion, in which the pole and the spacer are inserted, and the cylindrical protrusion has a locking part, which is able to stop the spacer from being inserted upward over a certain limit.

In this multi-stacking decorative flowerpot unit, preferably, wherein the pole has a round-shaped section, and the flowerpot rotates on the pole freely.

In this multi-stacking decorative flowerpot unit, preferably, wherein the flowerpot has a water storing portion, which is able to store certain amounts of water, and has a drain hole on the side face of the flowerpot in order to drain water, which have exceeded said certain amounts of water, and the height position of the drain hole is lower than the top position of the cylindrical protrusion.

In this multi-stacking decorative flowerpot unit, preferably, further comprising: an attachment style spacer, which has a cylindrical shape when the attachment style spacer is united, operable to be attached from the side of the pole in order to adjust its space between adjacent upper and lower flowerpots.

In this multi-stacking decorative flowerpot unit, preferably, wherein the flowerpot is an attachment style flowerpot having a bowl shape, said attachment style flowerpot is divided into right and left portions and is operable to be attached to the pole from the side of the pole.

The multi-stacking decorative flowerpot unit comprises a pole extending vertically, a plurality of flowerpots having a through hole, which is formed in a bottom part of the flowerpot in order to pass the pole though the flowerpot, and a spacer having a cylindrical shape and being placed between adjacent upper and lower flowerpots. And the pole, the flowerpot, and the spacer are united by passing the through hole and the spacer through the pole. This configuration makes it possible for many plants to be placed in a small space such as a room. And work efficiency and workability are improved, and the flexibility of its design and the quality of its display are enhanced by this configuration.

### BRIEF DESCRIPTION OF THE DRAWINGS

The present invention will be described hereinafter with reference to the annexed drawing. It is to be noted that the drawing is shown for the purpose of illustrating the technical concepts of the present invention or embodiments thereof, wherein:

FIG. 1A is a disassembled perspective view of a multi-stacking decorative flowerpot unit according to an embodiment of the present invention.

FIG. 1B is a perspective view of the multi-stacking decorative flowerpot unit.

FIG. 2A is a perspective view from the upper side of a flowerpot, which is used for the multi-stacking decorative flowerpot unit.

FIG. 2B is a perspective view from the bottom side of the flowerpot.

FIG. 3A is a top view of the flowerpot.

FIG. 3B is a bottom view of the flowerpot.

FIG. 4A is an A-A line cross section of the multi-stacking decorative flowerpot unit.

FIG. 4B is a cross section of another multi-stacking decorative flowerpot unit.

FIG. 5A and FIG. 5B are reference drawings to show its assembling process of the multi-stacking decorative flowerpot unit.

FIG. 6 is a reference drawing to show the applied example of the multi-stacking decorative flowerpot unit.

FIG. 7 is a reference drawing to show another applied example of the multi-stacking decorative flowerpot unit.

FIG. 8 is a reference drawing to show another applied example of the multi-stacking decorative flowerpot unit.

FIG. 9 is a reference drawing to show another applied example of the multi-stacking decorative flowerpot unit.

FIG. 10 is a reference drawing to show another applied example of the multi-stacking decorative flowerpot unit.

FIG. 11A is a disassembled perspective view of an attachment style spacer used for the multi-stacking decorative flowerpot unit according to Variation 1 of the embodiment.

FIG. 11B is a perspective view of the attachment style spacer.

FIG. 12A is a perspective view of a flowerpot used for the multi-stacking decorative flowerpot unit according to Variation 2 of the embodiment.

FIG. 12B is a upper view of said flowerpot.

FIG. 13A and FIG. 13B are reference drawings to show its assembling process of the multi-stacking decorative flowerpot unit according to Variation 2.

### DETAILED DESCRIPTION OF THE INVENTION

Embodiments of the present invention, as best mode for carrying out the invention, will be described hereinafter with reference to the drawing. It is to be understood that the embodiments described herein are not intended as limiting, or encompassing the entire scope of, the present invention.

### Embodiment

Referring to FIGs, a multi-stacking decorative flowerpot unit according to Embodiment of the present invention will be described. This multi-stacking decorative flowerpot unit can be used as an apparatus that can stack many flowerpots vertically by using a pole. The multi-stacking decorative flowerpot unit makes it possible for many plants to be placed not only for indoor space but also for outdoor space. Meanwhile, plant in this specification is not limited to a flower and a green plant, but include a foliage plant, a climbing vine and so on.

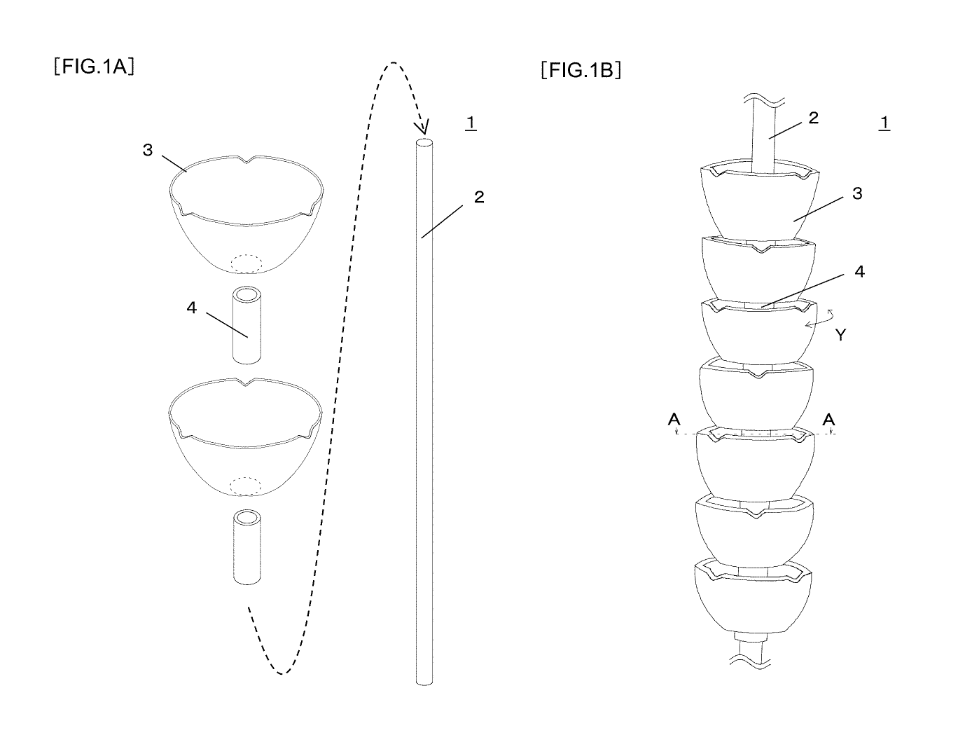

At first, referring to FIGS. 1A and 1B, the structure of the multi-stacking decorative flowerpot unit 1 according to the embodiment of the present invention will be described. The multi-stacking decorative flowerpot unit 1 comprises a pole 2, a flowerpot 3, and a spacer 4. As shown in FIG. 1A, the pole 2, the flowerpot 3, and the spacer 4 are united by passing the flowerpot 3 and the spacer 4 through the pole 2.

As shown in FIG. 1, the pole 2 is a part for stacking the flowerpot 3 and spacer 4 in a vertical direction. More specifically, the pole 2 is made from resin or metal and extends vertically. The pole 2 is hung vertically from the ceiling by using wires, or fixed at both upper and down position in order to keep its stability. The height of the pole 2 is such as 3˜7 m, and when the pole 2 has 1 m in height, it reaches 4 m by stacking four poles. It is needless to say that the height of the pole can be adjustable according to its purpose, its location, and the size of the planted plants.

The pole 2 is preferable to have a round-shaped section such as cylinder and column. In this case, as shown in FIG. 1B, a flowerpot 3 can rotate freely on the pole 2, which extends vertically. According to this structure, it is easy to design plants and easy to change a position of plants corresponding to the growth of plants. In other words, the position of plants is easily changed from the sun to the shade, or from the shade to the sun.

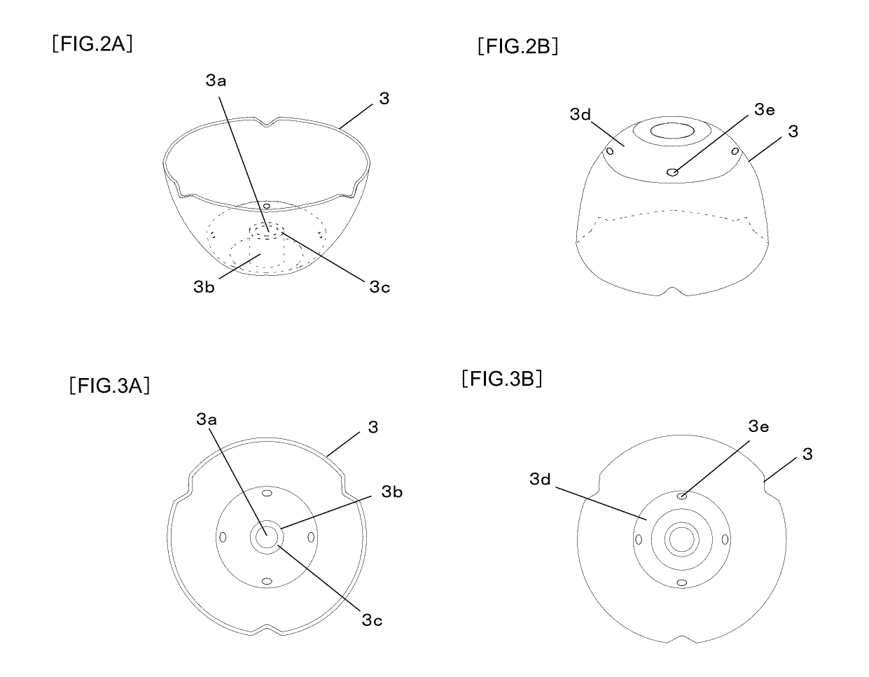

As shown in FIG. 2 and FIG. 3, the flowerpot 3 is a pot for placing plants. For example, the flower pot 3 is formed in the shape of a bowl having a inverse truncated cone shape, and is made of synthetic resin. The flower pot 3 has a through hole 3a, which is formed in a bottom part in order to pass the pole 2 through the flowerpot 3. More specifically, as shown in FIG. 2A, the flowerpot 3 has a cylindrical protrusion 3b on bottom thereof. The through hole 3a is formed on the top of the cylindrical protrusion 3b, And the cylindrical protrusion 3b has a hollow portion, in which the pole 2 and the spacer 4 are inserted.

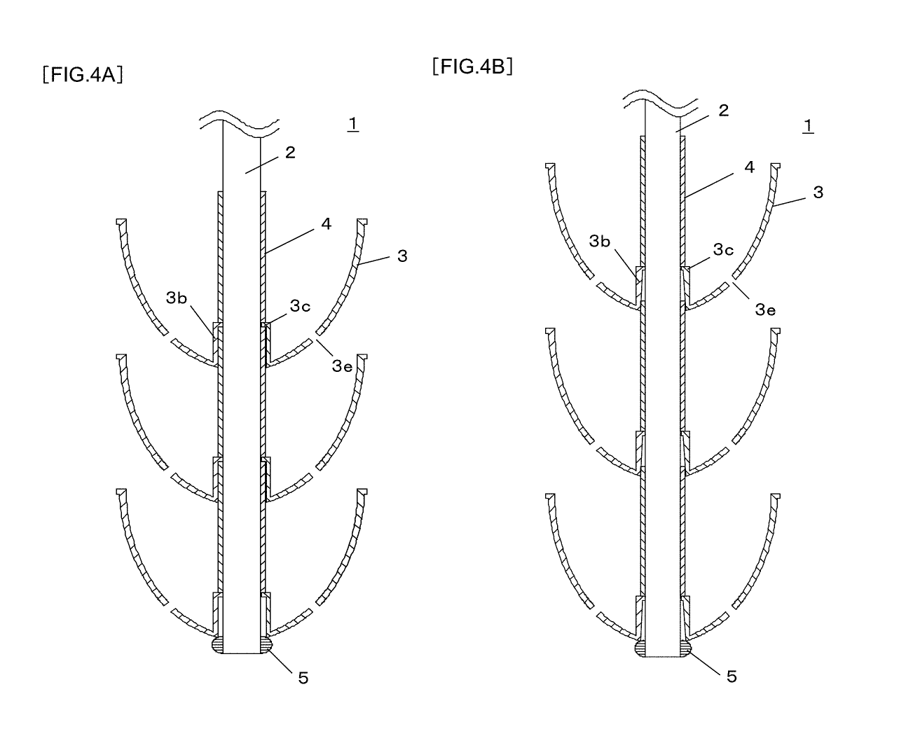

And, the cylindrical protrusion 3b has a locking part 3c (which is a stepped part in FIG. 4A), which is able to stop the spacer 4 from being inserted upward over a certain limit. Meanwhile, the shape of the locking part 3c is not limited to the shape shown in FIG. 4A. It is possible for the locking part 3c to have the shape, which becomes narrower as going upward, as shown in FIG. 4b. And, the locking part 3c is not necessary located at the top surface of the cylindrical protrusion 3b. It is possible for the locking part 3c to be made at the middle height of the cylindrical protrusion 3b.

As shown in FIG. 4, the bottom surface of the spacer 4 is put on the top surface of the cylindrical protrusion 3b. Based on this configuration, the flowerpot 3 can rotate freely on the pole 2, while a plurality of flowerpots 3 can be stacked by passing the hole 3a and the spacer 4 through the pole 2.

As shown in FIG. 2 and FIG. 3, the flowerpot 3 has a water storing portion 3d, which is able to store certain amounts of water, and has a drain hole 3e on the side face of the flowerpot 3 in order to drain water, which have exceeded said certain amounts of water, And the height of the drain hole 3e is lower than the top position of the cylindrical protrusion 3b as shown in FIG. 4A. By this configuration, the water can drop from the highest flowerpot 3 to the lowest flowerpot 3 through the drain hole 3e, Therefore, every plant can take water supply just by watering the highest flowerpot 3. And this configuration makes water supply easy and makes maintenance easy due to the water storing portion 3d. What is more, this configuration can prevent water from splashing outside and from flowing along the surface of the pole 2.

A plant, whose roots are covered with a water-permeable material having a water-retentivity and a water permeability and having 1˜2 cm in thickness such as spongy urethane foam and rock wool, is operable to be placed into the flowerpot 3. By this configuration, the multi-stacking decorative flowerpot unit 1 can be reduced in weight, and there is no mold smell emitting from soil. Moreover, this configuration can prevent soil from floating in the air indoors.

In other words, the way of planting is dependent on a plant which is used for the multi-stacking decorative flowerpot unit 1, on its place, and its purpose.

For example, when strawberry, herbs, or vegetables are grown outdoors or in a half-outdoor space such as a balcony, it is appropriate to fill plant culture soil in the flowerpot 3. On the other hand, soils are not required when decorating a foliage plant such in an apartment room, a foliage plant whose roots are covered by a sponge is put into the flowerpot 3 and it is better to fix the plant with pumice stones. In this case, there are advantages that various plants can be placed in a space such as a hospital where sanitization management and so on are required. And when using the multi-stacking decorative flowerpot unit 1 in commercial facilities for temporary events, etc, plants whose roots are covered with a sponge or a nonwoven fabric are grown at farm beforehand. Then the plants are carried into the place. And the plants are placed in the flowerpots 3. In this way, the multi-stacking decorative flowerpot unit 1 can provide an excellent display shortly and improve work efficiency.

The diameter of the flowerpot 3 is such as 20˜50 cm, and the amount of the flowerpot 3 is various so that the place where the multi-stacking decorative flowerpot unit 1 is placed and the size of the plants can be flexible.

As shown in FIG. 2, some recessed portions can be made at the upper edge of the flowerpot 3 for placing plants.

As shown in FIG. 1, the spacer 4 has a cylindrical shape and is placed between adjacent upper flowerpot 3 and lower flowerpot 3 in order to stack the flowerpot 3 at a specific interval in a vertical direction. Meanwhile, the specific interval may be regular or may be adjustable according to the size of the flowerpot 3 and plants. The spacer 4 is made of polystylene-based resin or vinyl chloride, and is inserted into the cylindrical protrusion 3b, which is formed in the flowerpot 3, from below. The spacer 4 is removable from the flowerpot 3.

The height of the spacer 4 is for example 15 cm, and is adjustable according to the location and the size of the plants. Meanwhile, the structure of spacer 4 is not limited to a cylindrical shape. As long as the spacer 4 can pass through the pole 2 and keep a specific interval between upper flowerpot 3 and lower flowerpot 3, another structure is possible.

Further, by utilizing the multi-stacking decorative flowerpot unit 1 having this structure, many plants can be placed indoors without requiring large space. Therefore, the multi-stacking decorative flowerpot unit 1 can improve housing conditions. What is more, by utilizing three-dimensional space, a family with a small child can manage and enjoy the multi-stacking decorative flowerpot unit 1 safely and can increase green indoors. Eventually, this invention will lead to improving environment.

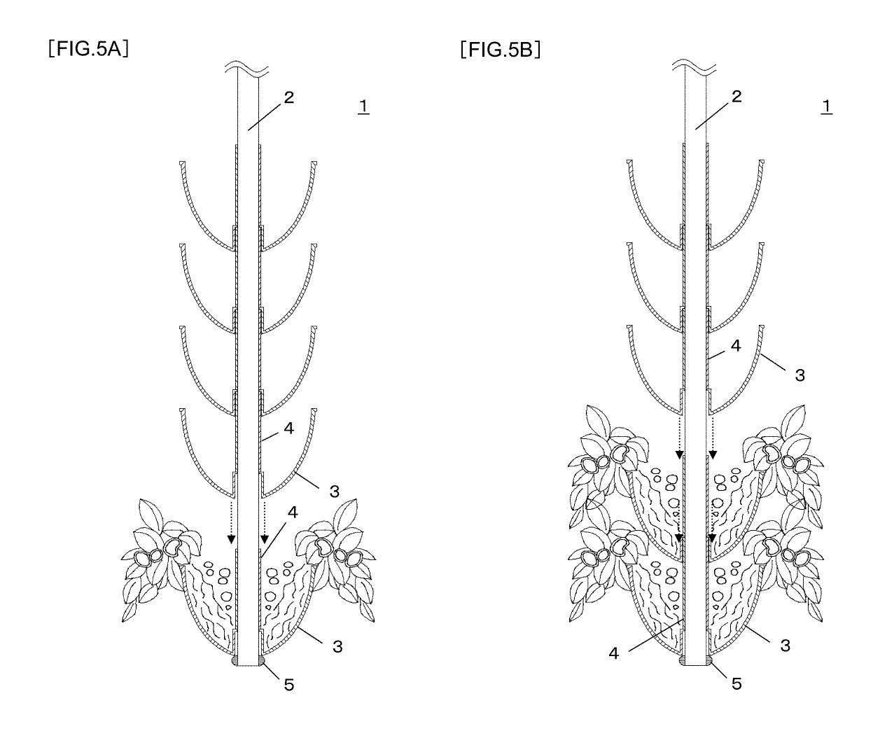

Hereinafter, referring to FIG. 5, a method for planting plants utilizing the multi-stacking decorative flowerpot unit 1 will be described. Firstly, as shown in FIG. 5A, the flowerpot 3 and the spacer 4 are united by passing them through the pole 2, which extends in a vertical direction. Then plants are placed into the flowerpot 3 by lifting the upper flowerpot 3 and the spacer 4 upward so that the space between upper and lower flowerpots 3 can be kept wide. Next, as shown in FIG. 5B, the lifted upper flowerpot 3 and the spacer 4 are lowered, then the lower spacer 4 is inserted into the cylindrical protrusion 3b of the upper flowerpot 3. Then plants are placed into the upper flowerpot 3. And plants are placed in every flowerpot 3 by repeating above mentioned procedures. According to this planting method, the multi-stacking decorative flowerpot unit 1 can create three-dimensional greenery with various plants for a very short period. Further, plants whose roots covered with a water-permeable material can be placed into the flower pot 3. Meanwhile, as shown in FIG. 5, the lowest flowerpot 3 is fixed to the pole 2 with a fixing tool 5.

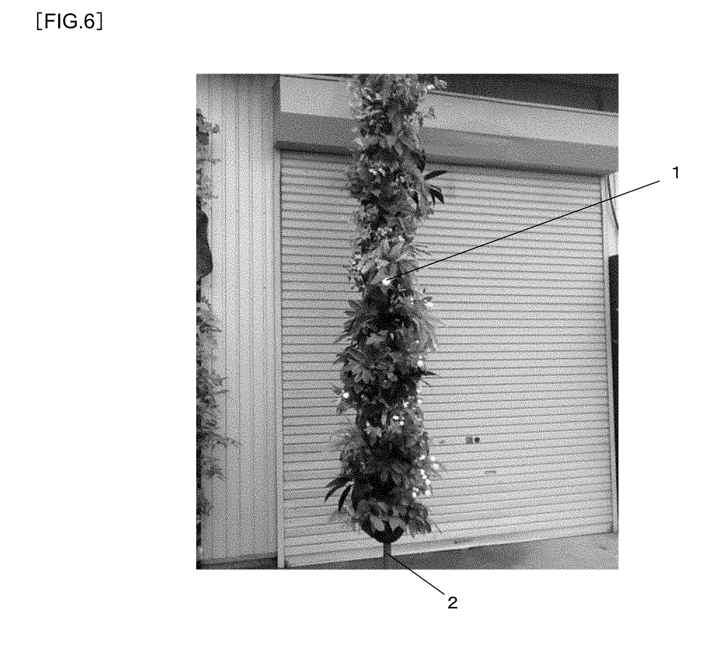

Hereinafter, referring to FIG. 6˜10, concrete installation examples of the multi-stacking decorative flowerpot unit 1 will be described. These figures make us understand that the multi-stacking decorative flowerpot unit 1 can provide various new proposals to “lives between humans and flowers or green”.

Referring to FIG. 6, the multi-stacking decorative flowerpot unit 1, which uses the pole 2 standing vertically, is placed for example on the side of a road in parallel.

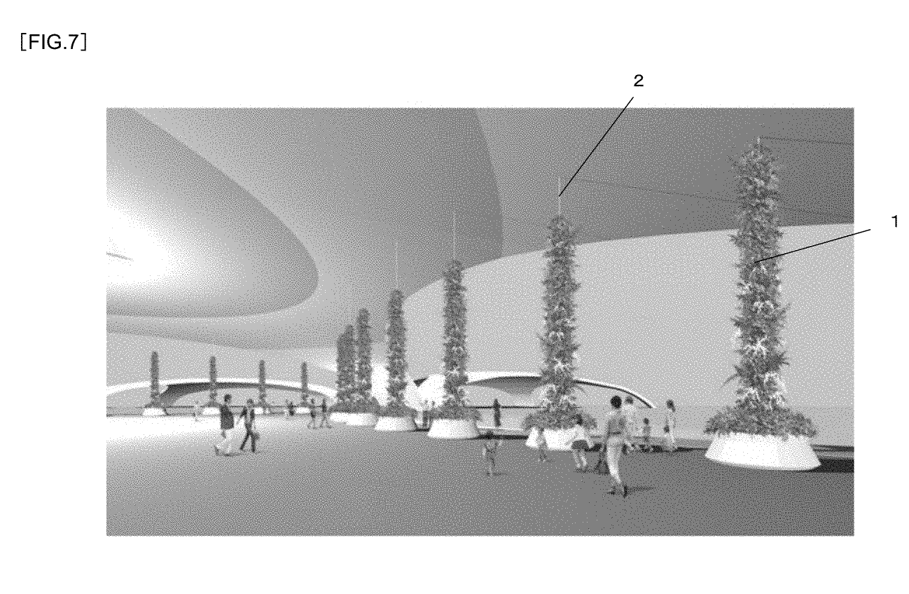

Referring to FIG. 7, the multi-stacking decorative flowerpot unit 1, whose height is about 3˜7 m, can design large indoor space. The pole 2 is fixed at both upper and lower parts so that the multi-stacking decorative flowerpot unit 1 can be very stable. The multi-stacking decorative flowerpot unit 1 can be used in an event such as the coming Tokyo Olympic Games and also be used as a decoration at the entrance of a commercial building. To put it simply, the multi-stacking decorative flowerpot unit 1 can design many places as a plant decorating device.

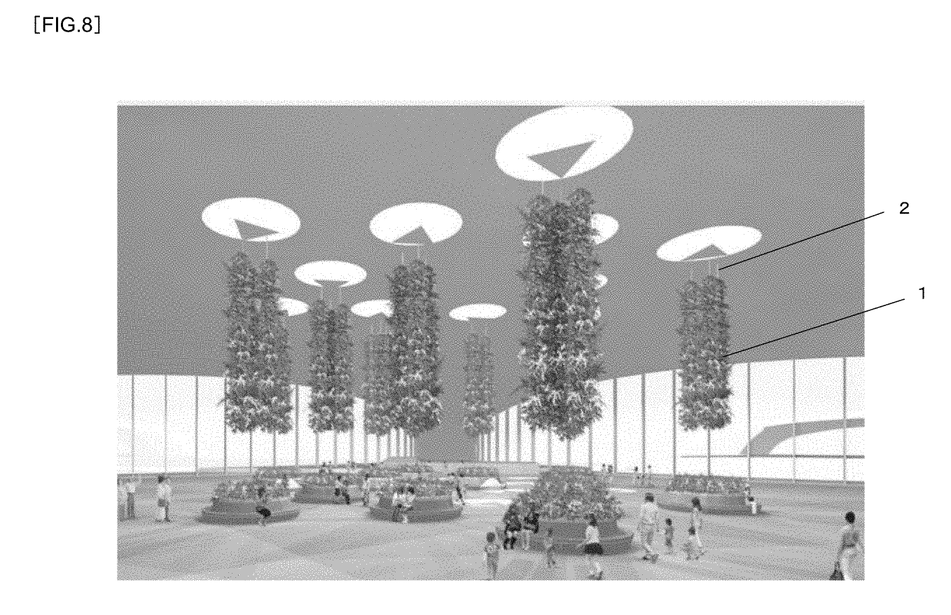

Referring to FIG. 8, the pole 2 of the multi-stacking decorative flowerpot unit 1 is hung from the ceiling by using wires. And the size of the flowerpot 3 is various so that the multi-stacking decorative flowerpot unit 1 can design various indoor space with full of green as a “green chandelier”. In other words, the multi-stacking decorative flowerpot unit 1 can realize a flower decoration that is excellent in quality.

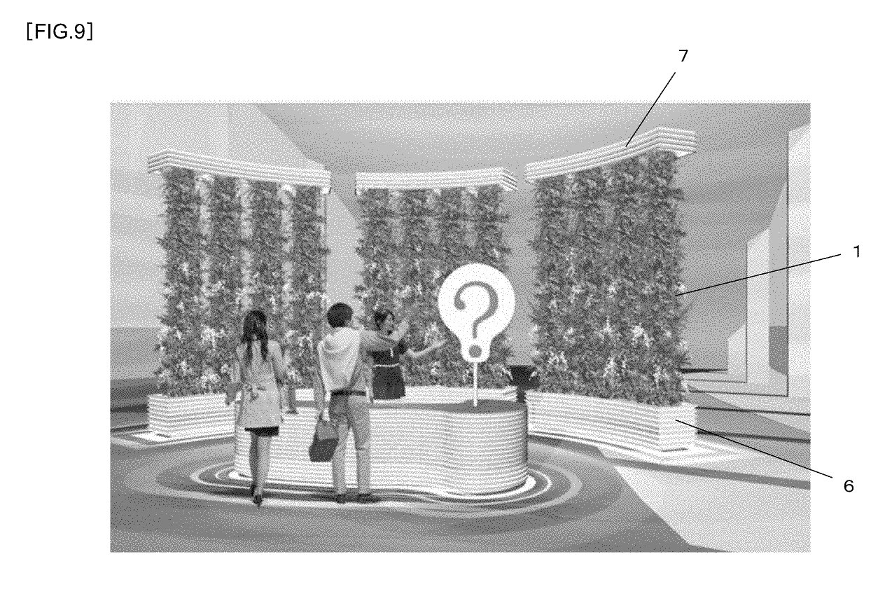

Referring to FIG. 9, the multi-stacking decorative flowerpot unit 1, whose height is about 3˜7 m, can be used at an office or at home. This multi-stacking decorative flowerpot unit 1 is used with a planter 6 underneath and a lighting box 7 above. The pole 2 is fixed both at upper and lower parts so that the pole 2 can be stable. The flowerpot 3 is stacked through the pole 2. In this case, the multi-stacking decorative flowerpot unit 1 can bring not only a green decoration, but also “many good effects from plant” indoors. In other words, the multi-stacking decorative flowerpot unit 1 can bring many effects such as air purification, moisture, decreasing eye strain into indoor space. And, indirect effects about indoor greening have already presented, that is, indoor greening can effect mental parts and improve work efficiency. Moreover, the multi-stacking decorative flowerpot unit 1 shown in FIG. 9 can be viewed from all directions so that it has high display effects. Therefore, the multi-stacking decorative flowerpot unit 1 can be used as a “green screen” when they are arranged in an office or a living space. Furthermore, when mixing the multi-stacking decorative flowerpot unit 1 with the wall-surface flower bed structure (refer to Japanese patent number 5223025), indoor green decoration can be enhanced more effectively.

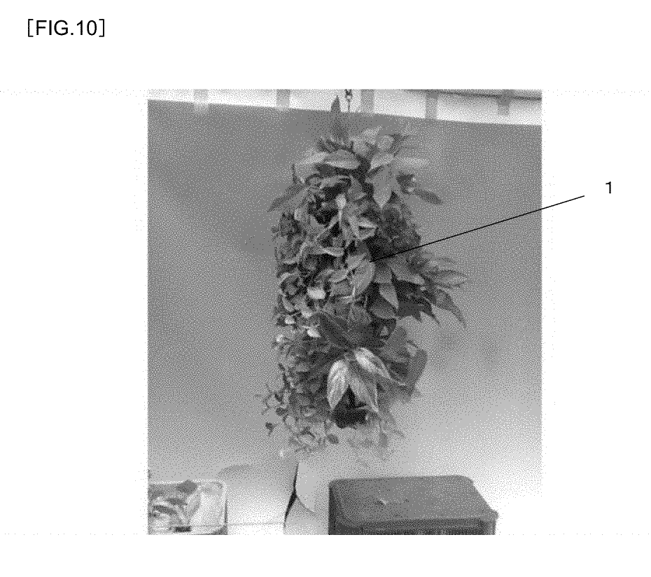

Referring to FIG. 10, the multi-stacking decorative flowerpot unit 1, whose height is about 1 m, can be used in a living space or a bay window at home. These days, it is difficult for people living in a high rise apartment house to take greens and flowers in their lives. By taking this multi-stacking decorative flowerpot unit 1 into their house, many greens can be brought into their houses even if indoor space is very limited. Therefore, not only air purification and moisture in a room are enhanced, but also relaxation in a bed room, sleep induction, and improving study efficiency can be realized.

Meanwhile, many data relating to indoor plant effects have already been disclosed by NASA in the US and so on. “How to make good air” by Kamal Meatle from TED.com is one example. And many Japanese researchers also have disclosed information relating to the effects of indoor green. However, a device for taking green into indoor space efficiently has not been proposed yet. Therefore, this invention means a lot especially to the people living in a high rise apartment house. Further, the idea of this multi-stacking decorative flowerpot unit 1, which can bring many effects of green into a room, can add a new value to plants.

Furthermore, it is significant that the multi-stacking decorative flowerpot unit 1 can contribute not only to the people living in a high rise apartment house, but also to Europeans having long winter (for example, eight months from October to May), people living in a high land, and people living in a very hot place having 50° C. in summer like middle east. They can take many green inside by using this invention. As mentioned above, the multi-stacking decorative flowerpot unit 1 can realize it.

As mentioned above, the multi-stacking decorative flowerpot unit 1 according to this Embodiment of the present invention, the multi-stacking decorative flowerpot unit 1 comprises the pole 2 extending vertically, a plurality of flowerpot 3 having the through hole 3a, which is formed in a bottom part in order to pass the pole 2 through the hole 3a, and the spacer 4 having a cylindrical shape and being placed between adjacent upper and lower flowerpots 3. And the pole 2, the flowerpot 3, and the spacer 4 are united by passing the hole 3a and the spacer 4 through the pole 2.

This configuration makes it possible for many plants to be placed inside such as a room without any large space. And work efficiency and workability are improved, and the flexibility of its design and the quality of its display are enhanced by this invention.

More specifically, the pole 2, the flowerpot 3, and the spacer 4 are light, and easy to carry and easy to construct. Therefore, the multi-stacking decorative flowerpot unit 1 can realize high work efficiency and workability.

And, the multi-stacking decorative flowerpot unit 1 can stand vertically or can be hung from the ceiling. As a result, indoor space is used efficiently, and many plants are placed in a limited small space such as indoor space.

In addition, the flowerpot 3 has the water storing portion 3d and the drain hole 3e. Therefore, all flowerpots 3 can be watered by watering the highest flowerpot 3 so that the maintenance for plant is very easy.

Further, plants whose roots are covered with the water-permeable material are placed into the flowerpot 3 so that the multi-stacking decorative flowerpot unit 1 can create three-dimensional scenery with various plants for a very short period. In other words, it is not necessary to wait until plants such as trees, which grow at a small growth speed, will be grown, if planted plants are grown by a contracted farmer. Moreover, because there is no need to use large amounts of soil, moldy smell will not be generated even if this invention is used for a long time.

Furthermore, the multi-stacking decorative flowerpot unit 1 can decorate each installation place according to its design needs, and can facilitate a layout change. This invention also has sophisticated design so that people can enjoy green. What is more, withered plants can be easily exchanged by exchanging plants which were placed into the flowerpot 3.

(First Variation)

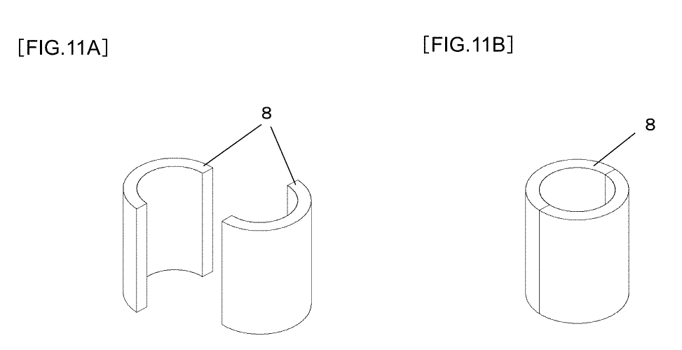

A variation 1 according to this Embodiment will be explained with reference to FIG. 11. The multi-stacking decorative flowerpot unit 1 according to this Variation 1 has an attachment style spacer 8 that can be attached from the side of the pole 2. More specifically, as shown in FIG. 11A, the spacer 8 can be divided into right and left portions. As shown in FIG. 11B, after the spacer 8 is united, the spacer 8 has a cylindrical shape. In other words, it is possible for the spacer 8 to be united in various ways such as fitting, engagement, junction, bonding, and so on.

According to this configuration, in addition to the effects of this Embodiment, the multi-stacking decorative flowerpot unit 1 according to Variation 1 can easily adjust its space between adjacent upper and lower flowerpots 3 based on a plant size, a plant kind, and the size of the flowerpot 3 by using the attachment style spacer 8. And, due to the attachment style spacer 8, it is not necessary to pull the flowerpot 3 and the spacer 8 from the top of the pole 2 so that work efficiency is improved well.

(Second Variation)

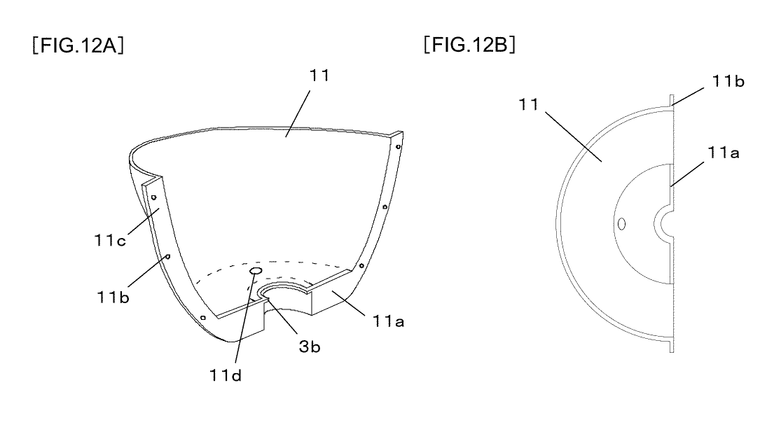

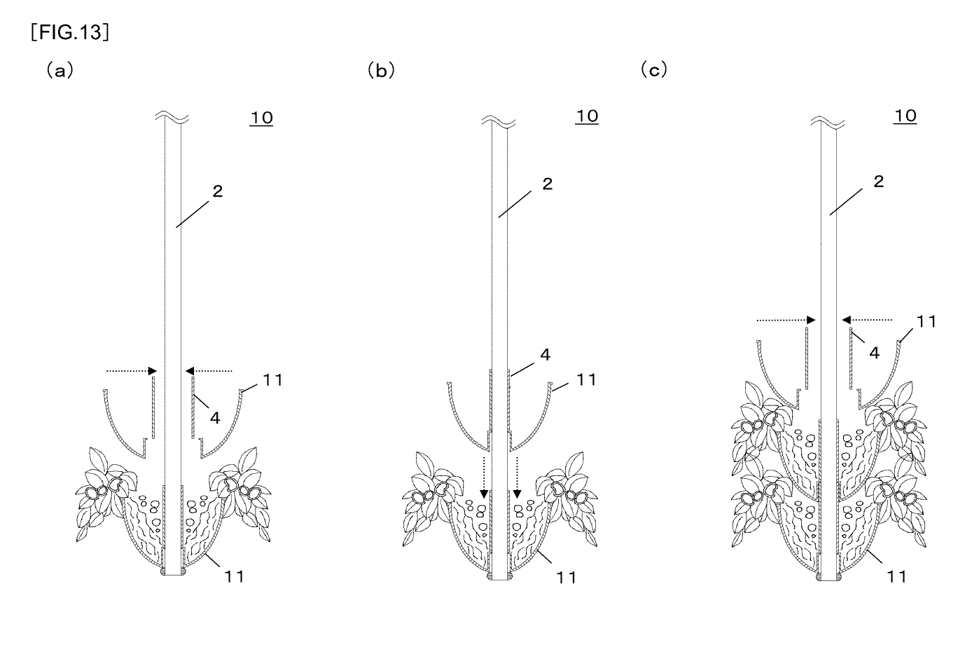

A variation 2 according to this Embodiment will be explained with reference to FIG. 12 and FIG. 13. According to Variation 2, a flowerpot 11 has an attachment style and can be attached to the pole 2 from the side of the pole 2. The flowerpot 11 is not needed to be passed through the pole 2 from the top.

As shown in FIG. 12A, the flowerpot 11 having a bowl shape having an inverse truncated cone shape. The attachment style flowerpot 11 is divided into right and left portions. The flowerpot 11 is attached to the pole 2 when the side aperture of the right and left portions is faced and is united along this direction. The erected face 11a, which is made to stock certain amounts of water in its bottom part. And the external rib 11c, which extends to the outside and has a few holes 11b for bolts and nuts, is formed in the side aperture of the flowerpot 11. Further, the flowerpot 11 has a drain hole 11d on the side in order to drain water which have excessed a water stocking level. Meanwhile, passing the bolts through the holes 11b of the external rib 11c for uniting two portions is just an example. It is needless to say that there are other ways to unite the two portions of the flowerpot 11.

Next, referring to FIG. 13, a method for planting plants in the multi-stacking decorative flowerpot unit 10 according to Variation 2 will be described. At first, as shown in FIG. 13A, the spacer 4 (the attachment style spacer 8 is also possible), and two flowerpots 11 are attached to the pole 2 which extends vertically from the side of the pole 2. The flowerpots 11 are united with bolts and nuts by passing the bolts through the holes 11b. Then plants are placed into the flowerpot 11. Next, as shown in FIG. 13B, the spacer 4 and the flowerpot 11 positioned upper side of the planted flowerpot 11 are attached to the pole 2 from the side of the pole 2. Then, as shown in FIG. 130, the lower positioned spacer 4 is inserted into the cylindrical protrusion 3b of the upper positioned flowerpot 11, then plants are placed in the upper positioned flowerpot 11. By repeating these procedures, it is possible for plants to be placed into every flowerpot 11.

According to this configuration, in addition to the effects of this Embodiment, it is not necessary to pass the flowerpot 11 and the spacer 4 through the pole 2 from its top. Therefore, the multi-stacking decorative flowerpot unit 10 according to Variation 2 can be very tall such as 7 m in height. In addition, work efficiency is improved well. Furthermore, the multi-stacking decorative flowerpot unit 10 can create three-dimensional greenery with various plants for a short period.

It is to be noted that the present invention is not limited to the above-described embodiments and modified examples, and various modifications are possible within the spirit and scope of the present invention. For example, the shape of the spacer 4 is not limited to the above mentioned shape. The spacer 4 is only required to have functions for being attached to the pole 2 from the side, and for adjusting the space between adjacent upper and lower flowerpots 3. Therefore, a spacer, which is expandable and contractible in the vertical direction, is operable to be used for this invention. This application is based on Japanese patent application 2016-093047 filed May 6, 2016 and Japanese patent application 2015-211681 filed Oct. 28, 2015, the content of which is hereby incorporated by reference.

1. A multi-stacking decorative flowerpot unit comprising:
a pole extending vertically;
a plurality of flowerpots being formed in the shape of a bowl having an inverse truncated cone shape and the flowerpot having a through hole, which is formed in a bottom part of the flowerpot in order to pass the pole through the flowerpot; and
a spacer having a cylindrical shape and being placed between adjacent upper and lower flowerpots in order to stack the flowerpot at a specific interval in a vertical direction,
wherein the pole, the flowerpot, and the spacer are united by passing the through hole and the spacer through the pole, the flowerpot has a cylindrical protrusion on bottom thereof, and the through hole is formed on the top of the cylindrical protrusion, and the cylindrical protrusion has a hollow portion, in which the pole and the spacer are inserted,
the cylindrical protrusion has a locking part, which is able to stop the spacer from being inserted upward over a certain limit,
the spacer is inserted into the cylindrical protrusion from below so that the flowerpot and the spacer are united, and
the height of the cylindrical protrusion is lower than the height of the flowerpot.

2. (canceled)

3. The multi-stacking decorative flowerpot unit according to claim 1,
wherein the pole has a round-shaped section, and
the flowerpot rotates on the pole freely.

4. The multi-stacking decorative flowerpot unit according to claim 1,
wherein the flowerpot has a water storing portion, which is able to store certain amounts of water, and has a drain hole on the side face of the flowerpot in order to drain water, which have exceeded said certain amounts of water, and
the height position of the drain hole is lower than the top position of the cylindrical protrusion.

5. The multi-stacking decorative flowerpot unit according to claim 1, further comprising:
an attachment style spacer, which has a cylindrical shape when the attachment style spacer is united, operable to be attached from the side of the pole in order to adjust its space between adjacent upper and lower flowerpots.

6. The multi-stacking decorative flowerpot unit according to claim 1,
wherein the flowerpot is an attachment style flowerpot having a bowl shape, said attachment style flowerpot is divided into right and left portions and is operable to be attached to the pole from the side of the pole.

7. The multi-stacking decorative flowerpot unit according to claim 3,
wherein the flowerpot is an attachment style flowerpot having a bowl shape, said attachment style flowerpot is divided into right and left portions and is operable to be attached to the pole from the side of the pole.

8. The multi-stacking decorative flowerpot unit according to claim 4,
wherein the flowerpot is an attachment style flowerpot having a bowl shape, said attachment style flowerpot is divided into right and left portions and is operable to be attached to the pole from the side of the pole.

9. The multi-stacking decorative flowerpot unit according to claim 5,
wherein the flowerpot is an attachment style flowerpot having a bowl shape, said attachment style flowerpot is divided into right and left portions and is operable to be attached to the pole from the side of the pole.
